(19) United States
(12) Patent Application Publication
(10) Pub. No.: US 2014/0096085 A1
(43) Pub. Date: Apr. 3, 2014

(54) REPRESENTING CRITICAL DATA FIELDS OF DATA TABLE

(71) Applicants: ANDRE ADAM, Walldorf (DE); PAUL SKIBA, Sandhausen (DE)

(72) Inventors: ANDRE ADAM, Walldorf (DE); PAUL SKIBA, Sandhausen (DE)

(21) Appl. No.: 13/629,632

(22) Filed: Sep. 28, 2012

(51) Int. Cl. G06F 3/048

(52) U.S. Cl. 715/846; 715/764

(57) ABSTRACT

Various embodiments of systems and methods for representing data fields of a data table are described herein. In one aspect, the method includes determining at least one data field of a data table. Data related to the determined at least one data field is read. A graphical representation of the data related to the determined at least one data field is generated. The generated graphical representation is displayed along with the data table. A user selection of a subset of data displayed on the graphical representation is received. A subset of the data table is displayed based upon the selected subset of data.

### BACKGROUND

A data table includes various data fields. For example, a data table for alerts may include the data fields such as alert name, alert status, person responsible for alert, risk value, risk sore, etc. Some of the data fields are critical and are more frequently analyzed. For example, ‘person responsible for alert,’ ‘risk score,’ and ‘risk value’ may be the critical data fields. The critical data fields are displayed along with other data fields in the data table. Therefore, it might be difficult to focus on the critical data fields. Further, each data field has one or more values or data. If the data table includes large volume of critical data corresponding to the critical data fields, a user may be required to scroll up-and-down or move between screens to see and analyze the critical data which might be inconvenient and time consuming.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a system including a graph generating module to generate a graphical representation of critical data fields of a data table, according to an embodiment.

FIG. 2 illustrates the data table including the critical data fields and non-critical data fields, according to an embodiment.

FIG. 3 illustrates the graphical representation generated for the critical data fields of the data table of FIG. 2, according to an embodiment.

FIG. 4A illustrates the data table related to alerts, according to an embodiment.

FIG. 4B illustrates another format of the data table related to alerts, according to an embodiment.

FIG. 5 illustrates the graphical representation generated for the critical data fields of the data table of FIG. 4A, according to an embodiment.

FIG. 6 illustrates the graphical representation of FIG. 5 including a filter option, according to an embodiment.

FIG. 7 illustrates the graphical representation of FIG. 6 displayed along with the data table, according to an embodiment.

FIG. 8 illustrates the data table including an icon for displaying the graphical representation, according to an embodiment.

FIG. 9 illustrates the critical data fields' data selected by a user on the graphical representation, according to an embodiment.

FIG. 10 illustrates the data table updated based upon the selection on the graphical representation of FIG. 9, according to an embodiment.

FIG. 11 is a flow chart illustrating the steps to generate a graphical representation of data fields of a data table and updating the data table based upon a selection of subset of data on the graphical representation, according to an embodiment.

FIG. 12 is a block diagram of an exemplary computer system, according to an embodiment.

### DETAILED DESCRIPTION

Embodiments of techniques for representing critical data fields of data tables are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

The following terminology is used while disclosing various embodiments. One skilled in the art will recognize that these terms and examples they are used in are merely illustrative.

Critical data fields are those fields of data tables which can be of more interest to a user or otherwise emphasized. What is critical may vary depending on the context. In one context, data fields of a data table which are more frequently analyzed by a user may be critical. For example, the data table related to laptops may include data fields such as brand name, RAM size, model, price, quantity sold, etc. For laptop dealers, the data fields namely brand name, model, and quantity sold may be more frequently analyzed and therefore critical. In some embodiments, the critical data fields are predefined. For example, if the data table is generated for the laptop dealers, then the data fields namely brand name, model, and quantity sold may be predefined as the critical data fields. In some embodiments, the critical data fields may be automatically determined at runtime, based upon the user's behavior, for instance. For example, the critical data fields may be determined at runtime by recording those data fields which are more frequently accessed by the user. In one embodiment, an access count of the data field is recorded and if the access count reaches a predefined number, the data field is automatically defined as the critical data field.

Non-critical data fields are data fields which are not often analyzed by the user, i.e., less frequently analyzed data fields. For example, taking the same example of the data table related to laptop, the data fields namely RAM size and price may not be frequently analyzed by the laptop dealers. Therefore, the data fields RAM size and price may be non-critical data fields for the laptop dealers. In those embodiments where the critical data fields are automatically determined at runtime, a non-critical may be converted to a critical data field based upon the user's behavior or access count.

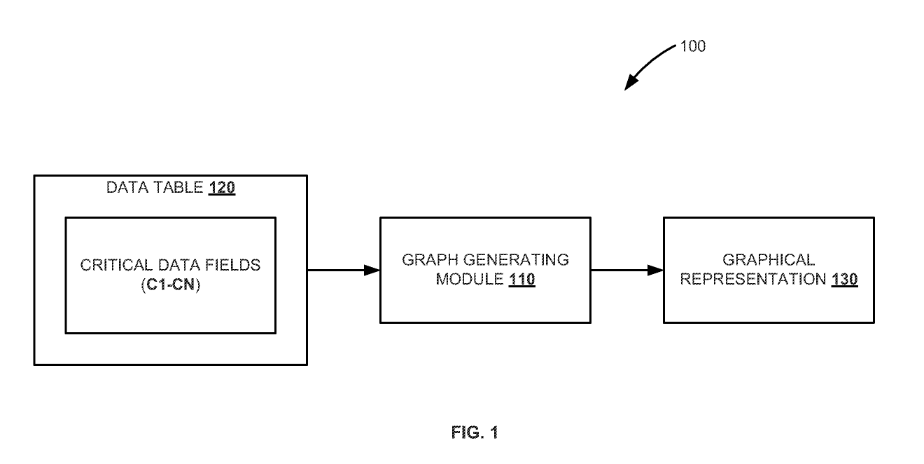

FIG. 1 illustrates one embodiment of a system 100 including a graph generating module 110 for representing data fields, e.g., critical data fields C1-CN, of a data table 120 in a graphical representation 130. The data table 120 includes a plurality of data fields. For example, the data table 120 may include the critical data fields C1-CN and non-critical data fields (not shown). The graph generating module 110 identifies the data fields (e.g., the critical data fields C1-CN) of the data table 120. In one embodiment, the data fields such as the critical data fields C1-CN are predefined at design time. Once the data fields (e.g., the critical data fields C1-CN) are identified, the graph generating module 110 reads data related to the identified data fields (e.g., the identified critical data fields C1-CN) from the data table 120. A graphical representation 130 of the data related to the identified data fields or the critical data fields C1-CN is generated. In one embodiment, the data are represented on an axis or a plane to generate the graphical representation 130. The generated graphical representation 130 of the data related to the identified data fields or the identified critical data fields C1-CN is displayed along with the data table 120.

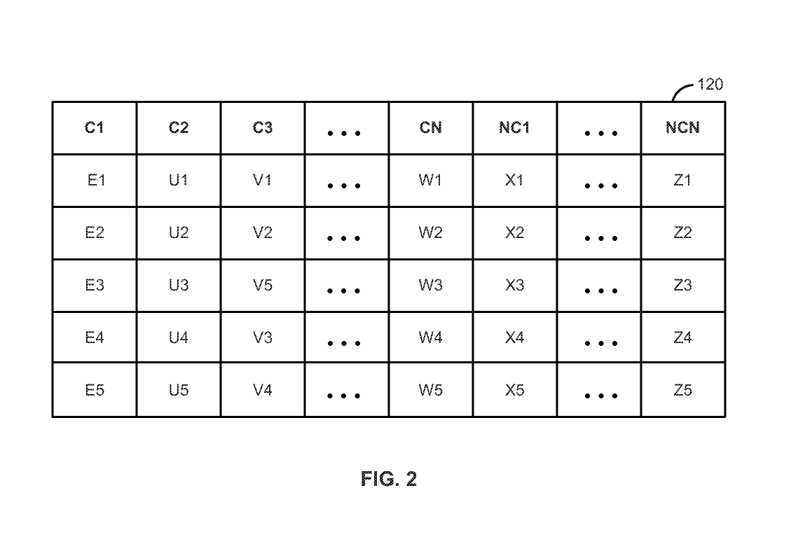

FIG. 2 illustrates the data table 120 including the critical data fields C1-CN and the non-critical data fields NC1-NCN. In some embodiments, the data table 120 may only include the critical data fields C1-CN. In some embodiments, the critical data fields C1-CN are the data fields which are more frequently analyzed by a user. In yet another embodiment, the critical data fields C1-CN are predefined at design time. In another embodiment, the critical data fields C1-CN are defined at runtime by the user. In yet another embodiment, the critical data fields C1-CN may be determined automatically at runtime. For example, the critical data fields may be determined by recording the data fields frequently accessed by the user.

Once the critical data fields C1-CN are identified, the graph generating module 110 reads the data related to the critical data fields C1-CN. The data table 120 includes values or data related to the critical data fields C1-CN and the non-critical data fields NC1-NCN. For example, the critical data field C1 has the values E1-E5, the critical data field C2 has the values U1-U5, the critical data field C3 has the values V1-V5, and the critical data field CN has the values W1-W5. The graph generating module 110 reads the data E1-E5, U1-U5, V1-V5, and W1-W5 related to the critical data fields C1, C2, C3, and CN, respectively.

Once the data of the critical data fields C1-CN are read, the graph generating module 110 generates the graphical representation 130 of the data related to the critical data fields C1-CN. In one embodiment, the graph generating module 110 identifies the axis or coordinates associated with the critical data fields C1-CN. The axis for critical data fields C1-CN may be predefined. For example, it may be predefined that the critical data field C2 is to be represented on an X axis, the critical data field C3 is to be represented on a Y axis, and the critical data field C1 is to be represented relative to the critical data fields C2 and C3. For example, the critical data field C1 may be represented as (x, y) coordinate on an X-Y plane. In one embodiment, some critical data fields, e.g., the critical data field CN may be represented as different colors or shades on the graphical representation 130. In one embodiment, some rules may be predefined for assigning the axis to the critical data fields C1-CN at runtime. For example, a rule may be defined as “represent a highest accessed data field on the X axis” and “represent a second highest accessed data field on the Y aris.”

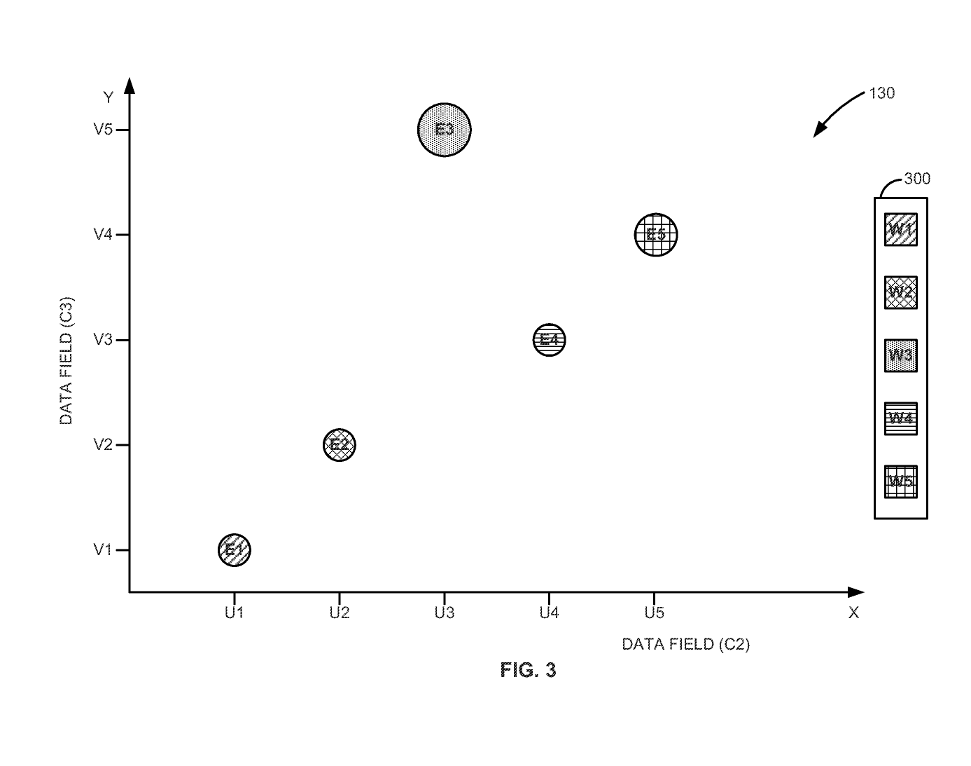

Once the axis associated with the critical data fields C1-CN are identified, the graph generating module 110 represents the data related to the critical data fields C1-CN on their identified axis. For example, as illustrated in FIG. 3, the data E1-E5 of the critical data field C1 is represented on the X-Y plane, the data U1-U5 of the critical data field C2 is represented on the X axis, the data V1-V5 of the critical data field C3 is represented on the Y axis, and the data W1-W5 of the critical data field CN is represented as different shades and/or colors. An index 300 may be displayed on the graphical representation 130 to indicate which color or shade represents which data W1-W5. In one embodiment, the data U1-U5 and V1-V5 are not explicitly displayed on the X and Y axis and the X and/or Y axis just include standard data at a regular interval.

In one embodiment, the data related to the critical data fields C1-CN are rendered as geometrical shapes on the graphical representation 130. For example, as illustrated in FIG. 3, the data E1-E5 related to the critical data field C1 are represented as circles. In one embodiment, a property, e.g., a size, an area, a color, shape, etc., of the geometrical shape indicates a value of the data. For example, the area of the circles may indicate a specific value of the data E1-E5. Therefore, if the area of the circle E1 is smaller than the area of circle E3, then the value of the data E1 is smaller than the value of the data E3. Similarly, different colors or shades of the circles represent different data W1-W5. The data W1-W5 may indicate ‘a user.’ The index 300 may be provided to indicate which color or shade represents which user W1-W5. The index 300 may be displayed as colored squares on the graphical representation 130, as shown in FIG. 3. For example, a red color (shown as hashed shading) may represent the user W1, a blue color (shown as crossed shading) may represent the user W2, a green color (shown as dotted shading) may represent the user W3, a yellow color (shown as stripped shading) may represent the user W4, and an orange color (shown as grid shading) may represent the user W5.

In one embodiment, the circles, representing the data E1-E5, may be colored to show which data E1-E5 is assigned to which user W1-W5. For example, it can be identified that the data E1 is assigned to the user W1, the data E4 is assigned to the user W4, etc. In another embodiment, the circles may be tagged with their respective user name W1-W5 to indicate which data or circle is assigned to which user.

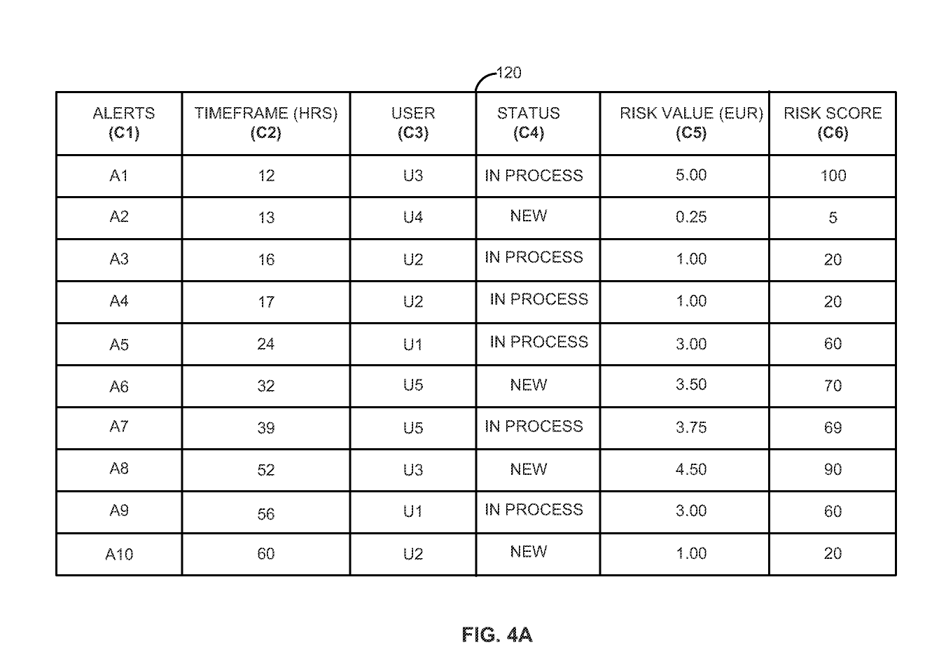

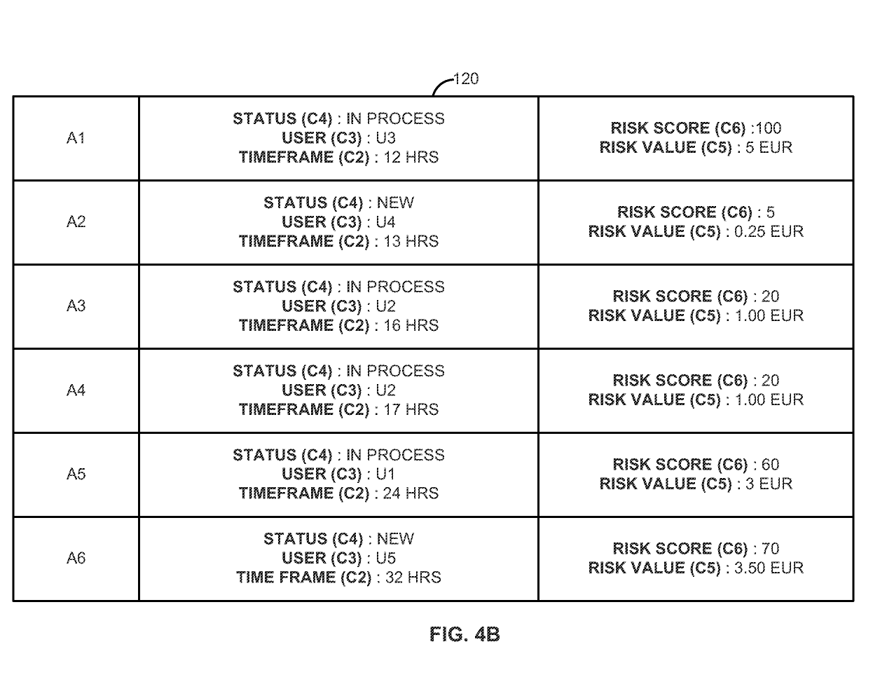

FIG. 4A illustrates the data table 120 related to alerts. The data table 120 includes the critical data fields C1-C6. For simplicity the non-critical data fields are not displayed. In one embodiment, the critical data field C1 represents ‘name of alerts’ and the critical data field C2 represents ‘timeframe.’ The timeframe C2 indicates the hours within which the alert is due. For example, the timeframe may have values, e.g., “12” to indicate that the alert is due within 12 hours. The critical data field C3 is a name of the ‘user’ to whom the alerts are assigned. For example, the alert A5 and A9 are assigned to the user U1. The critical data field C4 indicates a ‘status’ of the alert. The status may be ‘in process,’ ‘new,’ ‘closed,’ etc. The critical data field C5 indicates a ‘risk value’ of the alerts. A risk value is an actual value of the risk associated with the alert. The critical data field C6 indicates ‘risk score.’ A risk score indicates percentage risk of the alert. The risk score is calculated based upon the risk value of the alerts. The risk score is calculated based upon a highest risk value. For example, if the alert A1 has the highest risk value, e.g., 5.00 Euro, then the risk score 100 (highest risk score) is assigned to the alert A1. Therefore, the risk score 100 corresponds to risk value of 5.00 Euro. The risk score of other alerts A2-A 10 are calculated based on the risk score of the alert A1. For example, the risk score of the alert A2 having risk value 0.25 Euro may be calculated as ((0.25*100)/5) which is 5. The data table 120 related to alerts may be represented in any other format. One of the format may be as illustrated in FIG. 4B.

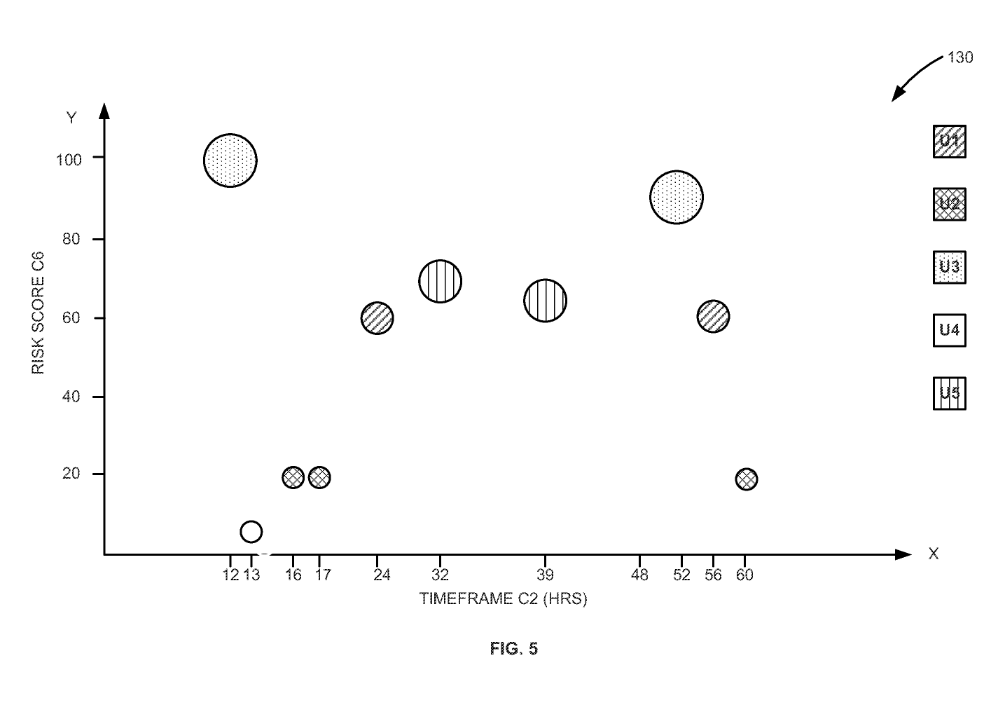

FIG. 5 illustrates the graphical representation 130 generated for the critical data fields C1-C6 of the data table 120 related to alerts. The critical data field C2 ‘timeframe’ is represented on the X axis. The data related to the critical data field C2, e.g., “12”, “13”, etc., are represented on the X axis. The critical data field C6 ‘risk score’ is represented on the Y axis. The data related to the critical data field C6, e.g., “20”, “40”, etc., are represented on the Y axis. The critical data field C3 ‘user’ is represented as different color or shades. The ‘user’ name is assigned a particular color and/or shade. For example, the user U1 may be assigned the red color (shown as hashed shading), the user U2 may be assigned the blue color (shown as crossed shading), the user U3 may be assigned the green color (shown as dotted shading), the user U4 may be assigned the yellow color (shown as blank square), and the user U5 may be assigned the orange color (shown as stripped shading). The critical data field C1 namely ‘alerts’ A1-A10 are represented as circles on the graphical representation 130. The size or area of the circle indicates the risk value C5 of each alert A1-A10. For example, the circle representing the alert A1 has bigger size, therefore, the alert A1 has bigger risk value compared to the alert A2. The color of the circles indicates the ‘user’ to whom the alert is assigned. For example, the alert A1 (dotted circle) indicates that the alert A1 is assigned to the user U3. In one embodiment, the blank circles may represent unassigned alert.

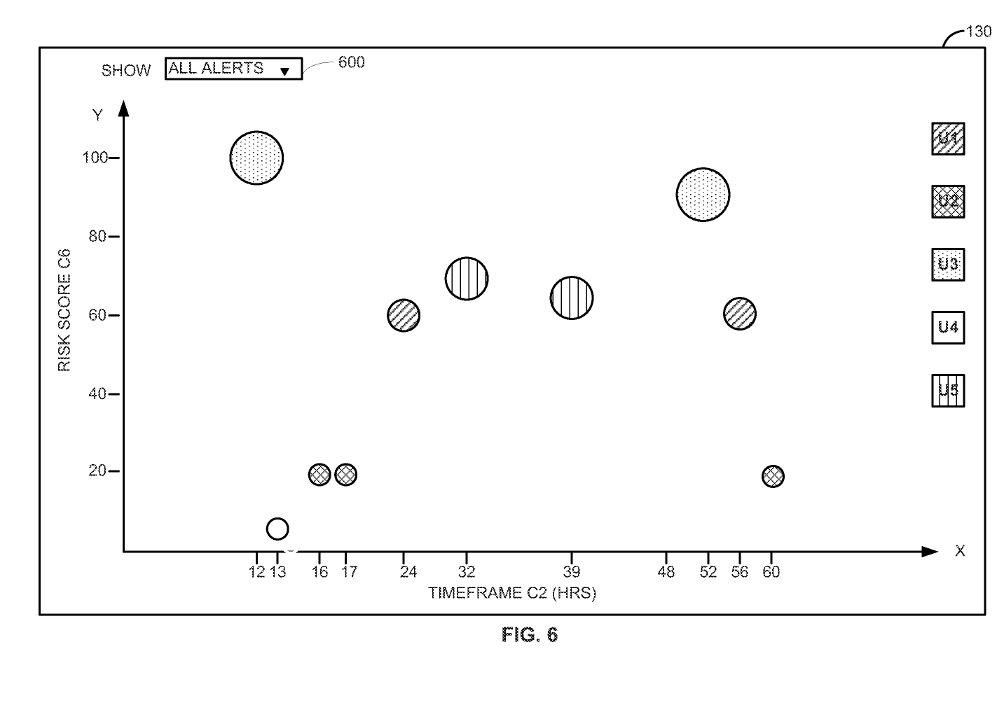

The user can analyze the graphical representation 130 to analyze the critical data fields (e.g., the risk score C6, the timeframe C2, and the user C3) related to the alerts A1-A10. For example, all unassigned alerts (blank circles in FIG. 5) can be analyzed at once on the graphical representation 130. The critical data field C5 (risk value) of FIG. 4A can also be analyzed by analyzing the size of the circles on the graphical representation 130. In one embodiment, the graphical representation 130 may also include a filter element or a filter 600, as shown in FIG. 6. The filter 600 may be a dropdown menu. The filter 600 may be related to the critical data fields C4 or status of the alerts. Therefore, the filter 600 includes various filter options. The filter options may be the value of the status C4 namely ‘in process’, ‘open alerts’, ‘all alerts’, ‘new alerts’, etc. The user can select the status C4 from the dropdown menu as per their requirement. For example, the user may select the status ‘all alerts’ from the dropdown menu or filter 600. When ‘all alerts’ are selected, the graphical representation 130 displays all the alerts A1-A10 of the data table 120. Therefore, all the alerts A1-A 10 can be analyzed at once on the graphical representation 130. Similarly, if the status ‘new alerts’ is selected from the filter 600, the graphical represents 130 can only display the new alerts A2, A6, A8, and A10 of the data table 120. In one embodiment, more than one filter, related to other critical data fields, may be provided on the graphical representation 130.

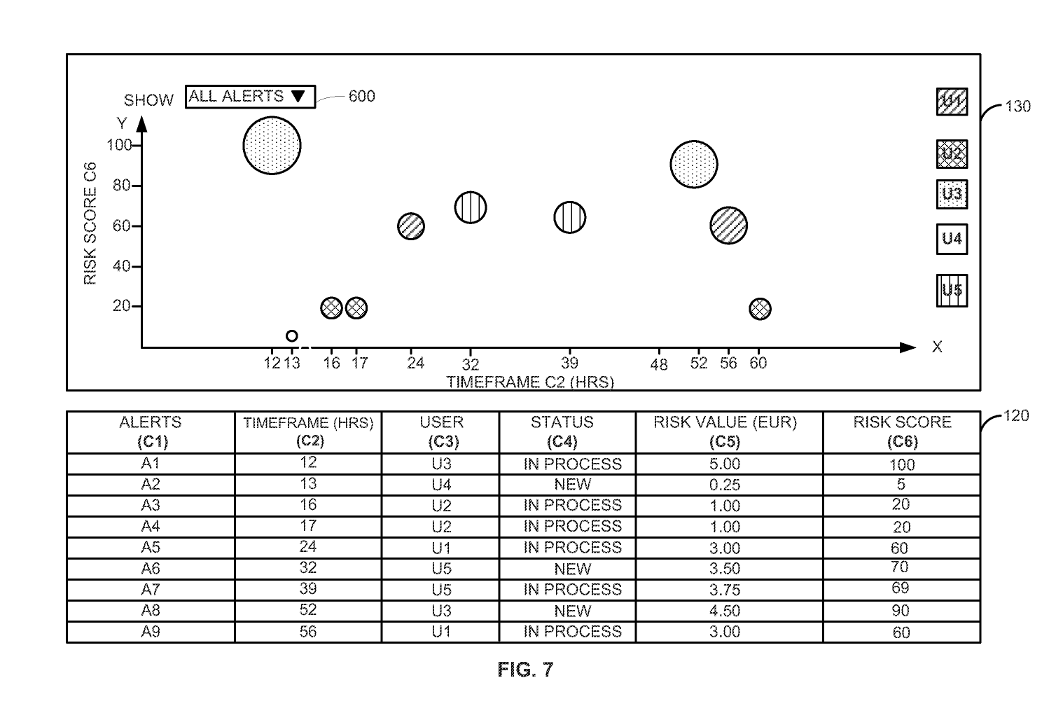

In one embodiment, as illustrated in FIG. 7, the graphical representation 130 of the critical data fields C1-C6 is displayed along with the data table 120. As shown, some rows of the data table 120 might get truncated and cannot be shown on the same screen, e.g., the row related to the alert A10 is truncated. The truncated row may either be shown in a next screen or may be shown further down the same screen. If the truncated row is included further down the same screen, the user can scroll down to see the truncated row, e.g., the row related to the alert A10. In one embodiment, the graphical representation 130 is displayed in a horizontal orientation relative to the data table 120, e.g., on the top of the data table 120, as shown in FIG. 7. In another embodiment, the graphical representation 130 may be displayed in a vertical orientation relative to the data table 120. In one embodiment, the user can select the orientation of their choice. In one embodiment, the user can change the orientation by using a drag-and-drop option.

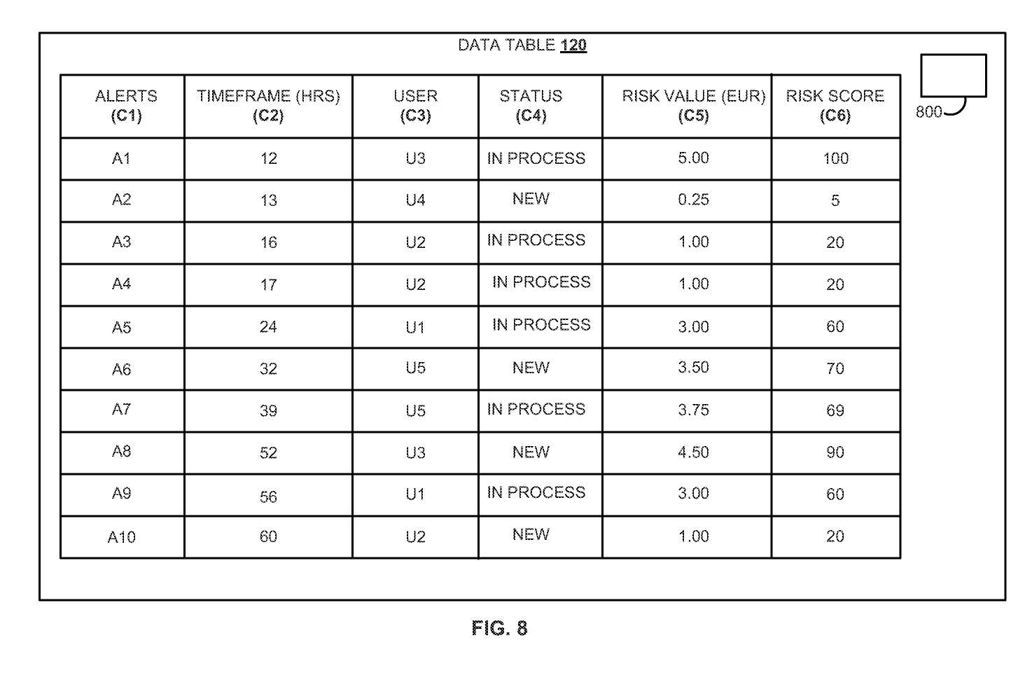

In one embodiment, the graphical representation 130 of the critical data fields C1-C6 is displayed automatically when the data table 120 is opened. In another embodiment, as illustrated in FIG. 8, the data table 120 includes an UI element, e.g., an icon 800 for instantiating the graphical representation 130 of the critical data fields C1-C6. The graphical representation 130 of the critical data fields C1-C6 is displayed upon selecting the icon 800. In one embodiment, once the icon 800 is selected, the graph generating module 110 reads the critical data fields C1-C6 of the data table 120 to generate the graphical representation 130 of the critical data fields C1-C6. The graphical representation 130 is then displayed instantly.

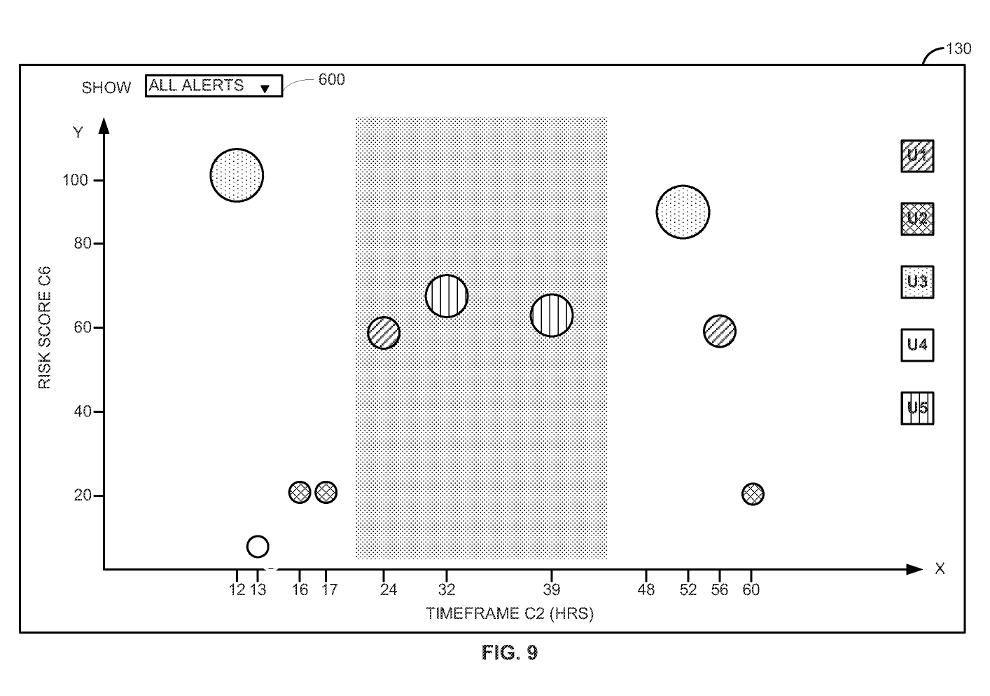

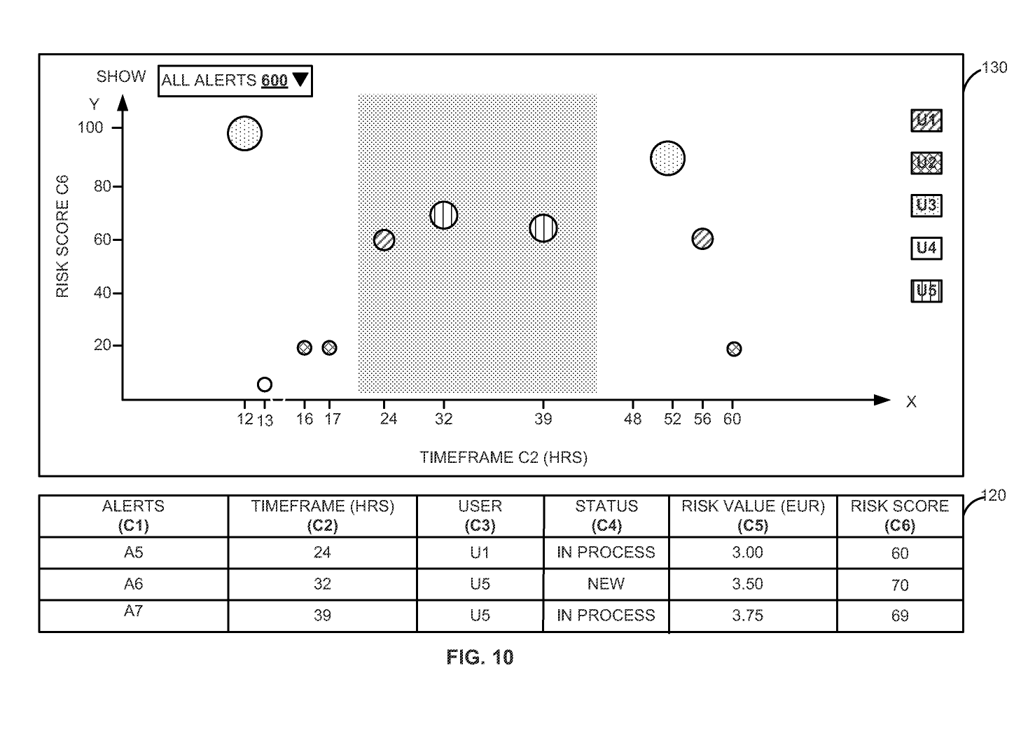

In one embodiment, the user can select an area including a subset of data on the graphical representation 130. For example, as illustrated in FIG. 9, the subset of data or alerts A5-A7 (shown as dotted area) may be selected by the user. In one embodiment, the user can select the area by normal selection operation, e.g., using a mouse. Based upon the selection, the data table 120 is updated accordingly on the fly. For example, if the selected area includes the alerts A5-A7, then the data table 120 is updated to display only the selected subset of data, e.g., the data related to the alerts A5-A7, as illustrated in FIG. 10. In one embodiment, a subset of the data table 120 (e.g., rows related to the data A5-A7) is displayed based upon the selected subset of the data, i.e., A5-A7. Therefore, the user can select and analyze the data clearly, based upon their selection.

In one embodiment, the graphical representation 130 may be modified based upon a modification in the data table 120. For example, if the alert A1 having the highest risk value 5.00 Euro is ‘closed’ then the risk score C6 of all other alerts A2-A10 would be affected or changed. A new risk score C6 would be calculated based upon the next highest risk value, i.e., 4.50 Euro. Now, 4.50 Euro would corresponds to the risk score 100. Therefore, the risk score C6 of all the alerts A2-A10 would increase and the circles would move vertically (upward) on the Y axis of the graphical representation 130. The circles would not move horizontally, as the timeframe C2 within which the alerts A2-A10 are due is still the same. Therefore, according to one embodiment, the graphical representation 130 can be modified based upon the modification in the data table 120. In one embodiment, the graphical representation 130 is modified on the fly or instantly.

In one embodiment, the same method may be applied for representing the non-critical data fields NC1-NCN graphically. In another embodiment, a combination of critical data fields C1-CN and the non-critical data fields NC1-NCN may be represented graphically using the above described method.

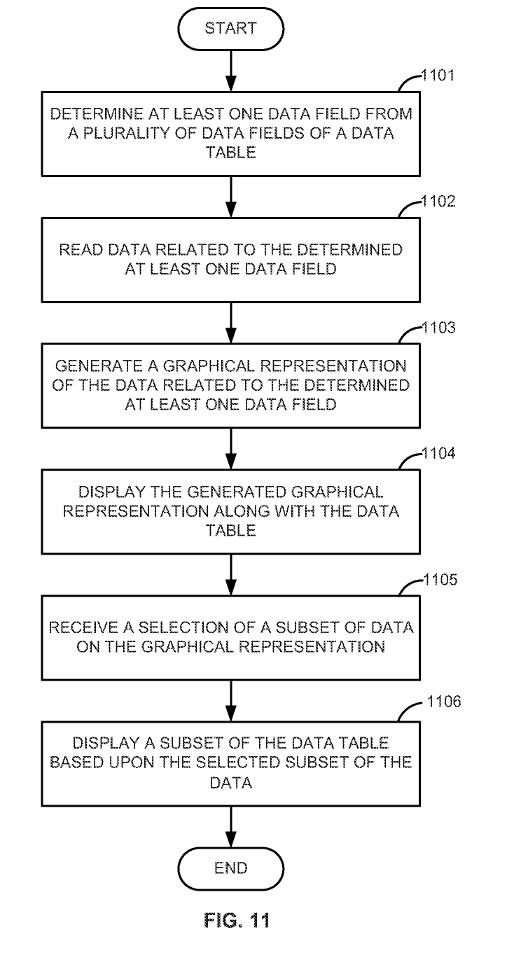

FIG. 11 is a flowchart illustrating a method for generating the graphical representation 130 of the data fields (e.g., the critical data fields C1-CN) of the data table 120, according to an embodiment. The graphical representation 130 may be generated upon receiving the command from the user. According to one embodiment, the command may be provided through the icon 800 provided on the same user interface screen as the one displaying data table 120. The data table 120 includes the critical data fields C1-CN and the non-critical data fields NC1-NCN. The graph generating module 110 determines the one or more data fields (e.g., the one or more critical data fields C1-CN) of the data table 120 at step 1101. Once the one or more data fields or the critical data fields C1-CN are determined, the graph generating module 110 reads the data related to the determined data fields (e.g., the determined critical data fields C1-CN) at step 1102. The graph generating module 110 generates the graphical representation 130 of the data related to the determined data fields (e.g., the determined critical data fields C1-CN) at step 1103. In one embodiment, the graphical representation 130 is generated by rendering the data using the axis or the coordinates associated with their respective data fields (e.g., with their respective critical data fields C1-CN). The graphical representation 130 is displayed along with the data table 120 at step 1104.

The data table 120 may be modified based upon the selection of areas on the graphical representation 130. The area including the subset of data, e.g., A5-A7, may be selected by the user on the graphical representation 130 related to the critical data fields C1-C6. At step 1105, the user's selection of the subset of data A5-A7 is received on the graphical representation 130 of the critical data fields C1-C6. Once the user's selection of the subset of data A5-A7 is received, the data table 120 is updated to display only the selected subset of data A5-A7. Typically, the subset of the data table 120 (e.g., rows related to the data A5-A7) is displayed based upon the selected subset of the data at step 1106. Therefore, the user can further drill down the critical data represented on the graphical representation 130. The further drilling of data enables users to clearly and efficiently analyze or focus on the selected subset of data A5-A7 of their interest.

Embodiments described above enable rendering critical data fields separately. The critical data fields can be viewed together. Therefore, a user can focus on the critical data fields without being distracted. Further, the critical data fields are displayed in a graphical representation which makes analysis clear, easy, less time consuming, and efficient. A relationship between various critical data fields can also be easily analyzed on the graphical representation. The graphical representation may be rendered along with a data table. The graphical representation may be positioned in a vertical orientation or in a horizontal orientation relative to the data table. Users can select the orientation based upon their convenience. Further, the user can make selection on the graphical representation and based upon the selection, the data table is modified on the fly. Also, the graphical representation can be modified on the fly based upon the modification in the data table. Therefore, such modification of the graphical representation and the data table makes analysis more substantive.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

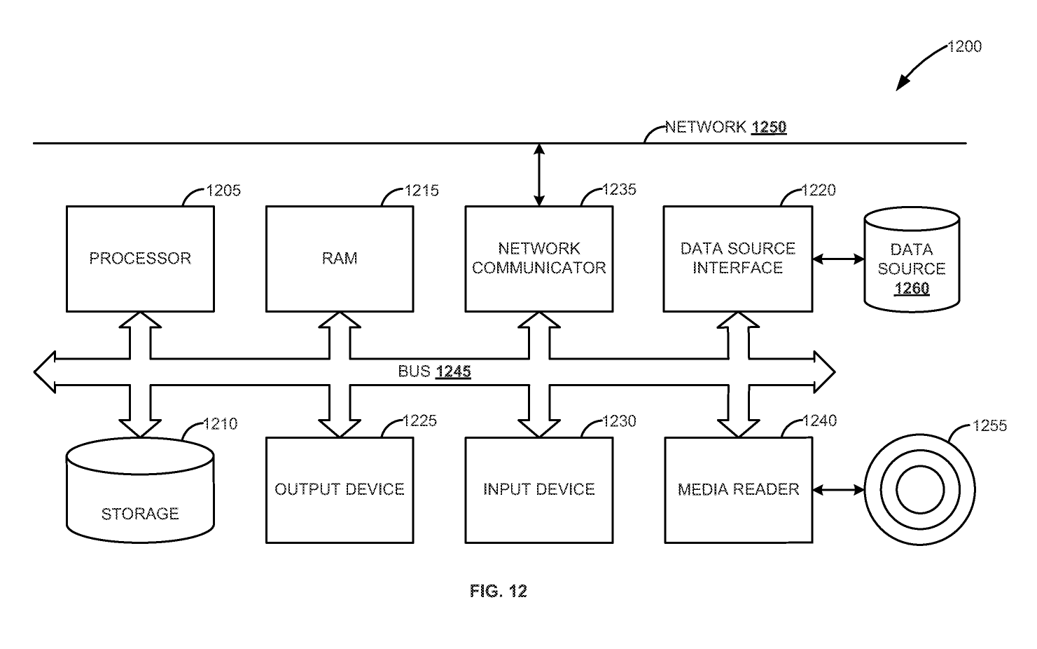

FIG. 12 is a block diagram of an exemplary computer system 1200. The computer system 1200 includes a processor 1205 that executes software instructions or code stored on a computer readable storage medium 1255 to perform the above-illustrated methods. The processor 1205 can include a plurality of cores. The computer system 1200 includes a media reader 1240 to read the instructions from the computer readable storage medium 1255 and store the instructions in storage 1210 or in random access memory (RAM) 1215. The storage 1210 provides a large space for keeping static data where at least some instructions could be stored for later execution. According to some embodiments, such as some in-memory computing system embodiments, the RAM 1215 can have sufficient storage capacity to store much of the data required for processing in the RAM 1215 instead of in the storage 1210. In some embodiments, all of the data required for processing may be stored in the RAM 1215. The stored instructions may be further compiled to generate other representations of the instructions and dynamically stored in the RAM 1215. The processor 1205 reads instructions from the RAM 1215 and performs actions as instructed. According to one embodiment, the computer system 1200 further includes an output device 1225 (e.g., a display) to provide at least some of the results of the execution as output including, but not limited to, visual information to users and an input device 1230 to provide a user or another device with means for entering data and/or otherwise interact with the computer system 1200. Each of these output devices 1225 and input devices 1230 could be joined by one or more additional peripherals to further expand the capabilities of the computer system 1200. A network communicator 1235 may be provided to connect the computer system 1200 to a network 1250 and in turn to other devices connected to the network 1250 including other clients, servers, data stores, and interfaces, for instance. The modules of the computer system 1200 are interconnected via a bus 1245. Computer system 1200 includes a data source interface 1220 to access data source 1260. The data source 1260 can be accessed via one or more abstraction layers implemented in hardware or software. For example, the data source 1260 may be accessed by network 1250. In some embodiments the data source 1260 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments are to be determined by the following claims, which are to be interpreted in accordance with established doctrines of claim construction.

What is claimed is:

1. An article of manufacture including a non-transitory computer readable storage medium to tangibly store instructions, which when executed cause one or more computers in a network of computers to:
determine at least one data field from a plurality of data fields of a data table;
read data related to the determined at least one data field;
generate a graphical representation of the data related to the determined at least one data field;
display the generated graphical representation along with the data table;
receive a selection of a subset of the data displayed on the graphical representation; and
display a subset of the data table based upon the selected subset of the data.

2. The article of manufacture of claim 1 further comprising instructions which when executed cause the one or more computers in the network of computers to:
identify a modification in the determined at least one data field of the data table; and
based upon the identified modification in the determined at least one data field, modify the graphical representation.

3. The article of manufacture of claim 1, wherein the data table is related to alerts and the determined at least one data field includes at least one of a risk score related to the alerts, a risk value related to the alerts, a time period within which the alerts are due, and a user responsible for the alerts.

4. The article of manufacture of claim 1, wherein the determined at least one data field is more frequently analyzed data field of the data table.

5. The article of manufacture of claim 1, wherein the determined at least one data field is predefined.

6. The article of manufacture of claim 1, wherein the graphical representation comprises a filter for the at least one data field of the plurality of data fields of the data table and one or more filter options are associated with the filter.

7. The article of manufacture of claim 6 further comprising instructions which when executed cause the one or more computers in the network of computers to:
receive a selection of a filter option from the one or more filter options; and
based upon the selection of the filter option, modify the graphical representation.

8. The article of manufacture of claim 1, wherein the graphical representation is displayed in one of a horizontal orientation and a vertical orientation relative to the data table.

9. The article of manufacture of claim 1, wherein the graphical representation is displayed upon receiving a command from a user.

10. A computer-implemented method for representing at least one data field of a data table, the method comprising:
determining the at least one data field from a plurality of data fields of the data table;
reading data related to the determined at least one data field;
generating a graphical representation of the data related to the determined at least one data field;
displaying the generated graphical representation along with the data table;
receiving a selection of a subset of the data displayed on the graphical representation; and
displaying a subset of the data table based upon the selected subset of the data.

11. The method of claim 10 further comprising:
identifying a modification in the determined at least one data field of the data table; and
based upon the identified modification in the determined at least one data field, modifying the graphical representation.

12. The method of claim 10, wherein the graphical representation is displayed upon receiving a user's command through a user interface element displayed on the data table.

13. The method of claim 10, wherein the data table is related to alerts and the determined at least one data field includes at least one of a risk score related to the alerts, a risk value related to the alerts, a time period within which the alerts are due, and a user responsible for the alerts.

14. The method of claim 10, wherein the graphical representation comprises a filter for the at least one data field of the plurality of data fields of the data table and one or more filter options are associated with the filter.

15. The method of claim 14 further comprising:
receiving a selection of a filter option from the one or more filter options; and
based upon the selection of the filter option, modifying the graphical representation.

16. A computer system for representing data fields of a data table, the computer system comprising:
a memory to store program code; and
a processor communicatively coupled to the memory, the processor configured to execute the program code to render a GUI, the GUI comprising:
a data table comprising at least one of:
one or more critical data fields and data corresponding to the one or more critical data fields; and
one or more non-critical data fields and data corresponding to the one or more non-critical data fields;
and
a graphical representation of the data related to at least one of the one or more critical data fields and the one or more non-critical data fields, the graphical representation comprising:
a plurality of selectable geometrical shapes representing the data related to the at least one of the critical data fields and the non-critical data fields, wherein the GUI is configured to receive a selection of one or more of the geometrical shapes and upon receiving the selection, a subset of the data table is displayed based upon the one or more selected geometrical shapes.

17. The computer system of claim 16, wherein the GUI further comprises an icon for performing one of:
displaying the graphical representation; and
hiding the graphical representation.

18. The computer system of claim 16, wherein the graphical representation further comprises a filter element for at least one of the one or more critical data fields and the one or more non-critical data fields and one or more selectable filter options is associated with the filter element.

19. The computer system of claim 16, wherein the graphical representation is displayed in one of a horizontal orientation and a vertical orientation relative to the data table.

20. The computer system of claim 16, wherein the data table is related to alerts and the one or more critical data fields include at least one of a risk score related to the alerts, a risk value related to the alerts, a time period within which the alerts are due, and a user responsible for the alerts.
